(19) United States
(12) Patent Application Publication
(10) Pub. No.: US 2021/0056395 A1
(43) Pub. Date: Feb. 25, 2021

(54) AUTOMATIC TESTING OF WEB PAGES USING AN ARTIFICIAL INTELLIGENCE ENGINE

(71) Applicant: TestCraft Technologies LTD., Tel Aviv-Yafo (IL)

(72) Inventor: Yarin Podoler, Tel Aviv (IL)

(21) Appl. No.: 16/547,699

(22) Filed: Aug. 22, 2019

(51) Int. Cl. G06N 3/04; G06N 3/08; G06F 11/36

(52) U.S. Cl. CPC G06N 3/0472; G06F 11/3688; G06N 3/08

(57) ABSTRACT

Computer-implemented methods, apparatus and computer program product, the methods comprising: obtaining a first set of attribute values assigned to a first set of attributes associated with an element to be searched for in a web page; obtaining a second set of attribute values assigned to a second set of attributes associated with an existing element present in the web page; providing the first set of attribute values and the second set of attribute values to an artificial intelligence engine; receiving from the artificial intelligence engine an indication whether the existing element is the element to be searched for; and subject to the existing element being a modification of the element to be searched for, performing an action upon the existing element.

### TECHNICAL FIELD

The present disclosure relates to testing in general, and to a method and apparatus for testing web pages, in particular.

### BACKGROUND

Computerized devices and applications control almost every aspect of our life—from writing documents to controlling traffic lights. However, computer applications, including web pages are bug-prone, and thus require a testing phase in which the bugs should be discovered. The testing phase is considered one of the most difficult tasks in designing a computerized device, or a computer application or even a simple web page.

Of particular interest are automated programs which are used for web pages testing purposes. Web pages typically comprise one or more elements, such as text boxes, buttons, hyperlinks, static elements, and others. Such automated programs simulate the operation of the web pages by a human, in a multiplicity of scenarios, inputs, or the like. The programs may use scripts or are otherwise provided with instructions on how to test the web page, for example which element on the page is to be operated upon, what action to perform, and optionally how to verify the result. Some tests need to be repeated when the action, the web page or any other part of the program is modified.

### BRIEF SUMMARY

One exemplary embodiment of the disclosed subject matter is a computer-implemented method performed by a computerized device, comprising: obtaining a first set of attribute values assigned to a first set of attributes associated with an element to be searched for in a web page; obtaining a second set of attribute values assigned to a second set of attributes associated with an existing element present in the web page; providing the first set of attribute values and the second set of attribute values to an artificial intelligence engine; receiving from the artificial intelligence engine an indication whether the existing element is the element to be searched for; and subject to the existing element being a modification of the element to be searched for, performing an action upon the existing element. The method can further comprise: receiving a web page and the first set of attribute values; identifying at least a subset of elements present on the web page; and repeating said obtaining the second set, said providing the first set of attribute values and the second set of attribute values to the artificial intelligence engine, and said receiving, for at least one element of the subset of elements; and performing the action upon the existing element subject to identifying the existing element from the subset for which the artificial intelligence engine provided an indication that the specific element is a modification of the element to be searched for. Within the method, subject to not identifying the specific element from the subset for which the artificial intelligence engine provided an indication that the specific element is a modification of the element to be searched for, optionally: prompting a user to identify the element modified from the element to be searched for; receiving an indication from the user to the element modified from the element to be searched for from the user; and performing the action upon the element modified from the element to be searched for. Within the method, the artificial intelligence engine is optionally a neural network. Within the method, the neural network optionally applies weights to differences between values from the first set of attribute values and values of corresponding attributes from the second set of attribute values. The method can further comprise training the neural network upon a multiplicity of input sets, each input set comprising: a first set of attribute values associated with a first element, a second set of attribute values associated with a second element, and an indication of whether the first element is the same as or a modification of the second element, or not. Within the method, the indication is optionally positive if a probability that the first element is the same as the second element exceeds a first threshold, and negative if the probability is below a second threshold, the second threshold being lower than the first threshold. Within the method, the probability is optionally obtained by an element matching system. Within the method, subject to the probability that the first element is the same as the second element being below the first threshold, and above the second threshold, a user is optionally asked whether the first element is the same as the second element.

Another exemplary embodiment of the disclosed subject matter is a computer-implemented method performed by a computerized device, comprising: obtaining a training set comprising a multiplicity of input sets, each input set comprising: a first training set of attribute values associated with a first training element, a second training set of attribute values associated with a second training element, and an indication of whether the second training element is a modification of the first training element; selecting a training set of attributes, such that in each input set the first training set and the second training set comprise values for at least one attribute from the training set of attributes; providing to an artificial intelligence training system at least a part of the training set, in which each input set comprises values associated with the training set of attributes from the first training set of attribute values, and values associated with the training set of attributes from the second training set of attribute values; and activating the artificial intelligence training system upon the at least part of the training set, to obtain an artificial intelligence engine, the artificial intelligence engine adapted to: receive a first runtime set of attribute values associated with a first runtime element, and a second runtime set of attribute values assigned to a second set of attributes associated with a second runtime element; and output an indication of whether the second runtime element is a modification of the first runtime element. Within the method, the artificial intelligence engine is optionally a neural network. Within the method, training the neural network comprises applying weights to differences between values from the first training set of attribute values and values of corresponding attributes from the second training set of attribute values. Within the method, the indication is optionally positive if a probability that the first training element is a modification of the second element exceeds a first threshold, and negative if the probability is below a second threshold, the second threshold being lower than the first threshold. Within the method, the probability is optionally obtained from an element matching system. Within the method, subject to the probability that the first training element is the same as the second element being between the first threshold and the second threshold, a user is optionally asked whether the first training element is the same as the second element.

Yet another exemplary embodiment of the disclosed subject matter is an apparatus having a processor, the processor being adapted to perform the steps of: obtaining a training set comprising a multiplicity of input sets, each input set comprising: a first training set of attribute values associated with a first training element, a second training set of attribute values associated with a second training element, and an indication of whether the second training element is a modification of the first training element; selecting a training set of attributes, such that in each input set the first training set and the second training set comprise values for at least one attribute from the training set of attributes; providing to an artificial intelligence training system at least a part of the training set, in which each input set comprises values associated with the training set of attributes from the first training set of attribute values, and values associated with the training set of attributes from the second training set of attribute values; and activating the artificial intelligence training system upon the at least part of the training set, to obtain an artificial intelligence engine, the artificial intelligence engine adapted to: receive a first runtime set of attribute values associated with a first runtime element, and a second runtime set of attribute values assigned to a second set of attributes associated with a second runtime element; and output an indication of whether the second runtime element is a modification of the first runtime element. Within the apparatus, the artificial intelligence engine is optionally a neural network. Within the apparatus, training the neural network optionally comprises applying weights to differences between values from the first training set of attribute values and values of corresponding attributes from the second training set of attribute values. Within the apparatus, the indication is optionally positive if a probability that the first training element is a modification of the second element exceeds a first threshold, and negative if the probability is below a second threshold, the second threshold being lower than the first threshold.

Yet another exemplary embodiment of the disclosed subject matter is a computer program product comprising a non-transitory computer readable medium retaining program instructions, which instructions when read by a processor, cause the processor to perform: obtaining a training set comprising a multiplicity of input sets, each input set comprising: a first training set of attribute values associated with a first training element, a second training set of attribute values associated with a second training element, and an indication of whether the second training element is a modification of the first training element; selecting a training set of attributes, such that in each input set the first training set and the second training set comprise values for at least one attribute from the training set of attributes; providing to an artificial intelligence training system at least a part of the training set, in which each input set comprises values associated with the training set of attributes from the first training set of attribute values, and values associated with the training set of attributes from the second training set of attribute values; and activating the artificial intelligence training system upon the at least part of the training set, to obtain an artificial intelligence engine, the artificial intelligence engine adapted to: receive a first runtime set of attribute values associated with a first runtime element, and a second runtime set of attribute values assigned to a second set of attributes associated with a second runtime element; and output an indication of whether the second runtime element is a modification of the first runtime element.

### BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1A is a schematic illustration of a web page;

FIG. 1B is a schematic illustration of the web page of FIG. 1A, after an element has been modified;

FIG. 2 is a generalized flowchart of a method for identifying elements in a web page, in accordance with some embodiments of the disclosure;

FIG. 3 is a generalized flowchart of a method for training an artificial engine for identifying elements in a web page, in accordance with some embodiments of the disclosure;

FIG. 4A is a histogram showing for some common attributes the percentage of the elements comprising each attribute in exemplary data;

FIG. 4B is a histogram showing for each number of attributes, the number of elements having this number of attributes in the exemplary data;

FIG. 4C shows graphs formed some numbers of attributes, the distribution of the percentage of elements having each number of attributes; and

FIG. 5 is a generalized block diagram of a system for web page testing, in accordance with some embodiments of the disclosure.

### DETAILED DESCRIPTION

One technical problem dealt with by the disclosed subject matter is the need to test the functionality of web pages comprising controls, for example by simulating operations taken by a human user of the web page in a multiplicity of scenarios. A human user or a simulation thereof can operate a web page using the controls, also referred to as elements, of the web pages. For example, the user can enter text, click on buttons, follow hyperlinks, mark checkboxes, toggle, or the like. The behavior can then be validated, for example by checking entered text, making visual comparisons, or the like.

Thus, web pages' functional test scenarios usually comprise sequences of one or more operations, wherein a sequence requires the identification of an element, also referred to as control, to be operated upon, and continues by performing one or more operations with or on the element.

Web applications today are generally built using HTML technology. Functional test automation for web applications relies heavily on identification of a single control, also referred to as a specific element, in order to take a simulate a user action, such as click, enter input, toggle, make a selection, or the like, or to validate the behavior, for example check text, compare visual appearance, or the like.

Multiple techniques have been designed for simulating operation of a web page. Most techniques use one or more identifiers, also referred to as attributes of the elements, such as a class, a location, an ID, an xPath, a color, or the like, to describe or identify elements. Upon the release of new versions, new features, user interface changes, or any other changes introduced to the program, in addition to testing the new features, previously passed tests have to be repeated to check regression, in order to verify that previously tested features are still functional, compatibility or the like. During test development, the attributes of the element and the values thereof are noted as a formula-like structure. In runtime, during testing, the formula is applied, the specific element is sought for and if found, is operated upon. However, elements may have changed during development, for example their technical attributes such as shape may have changed, they may have moved around the page, removed, their ID may have changed, or the like. Thus, any script or program designed to locate an element by comparing attribute values is subject to fail upon a change in the used attributes. For example, if an element identified by its location is moved, then the modified element will not be found. In cases in which the element is removed or not found, the test may not be performed and thus not fail, a situation referred to as false positive. In other situations, although the element exists, a wrong element may be identified as the required element, resulting in the test failure which may be referred to as false negative.

Another technical problem relates to the incompatibility of tests between different platforms, due to changes in attributes such as locations, which stem from the different displays used. Thus, tests designed for a web page as displayed on one platform may not be used as is for a different platform, and involvement of a test developer may be required for adjusting the test, thus incurring time and labor costs.

One technical solution comprises using an artificial intelligence engine for determining whether an element present on a web page is a modification of an element searched for, and thus tests or actions involving the searched element should be applied to the present element.

An artificial intelligence (AI) engine may receive as input a first set of attributes of an element to be searched for, a second set of attributes of an element of the web page, and provide an answer indicating whether the element on the web page is a modification of the element to be searched for (including situations of null modification, in which it is the same element without modification), or not. If the AI engine indicates that it is a modified element, an action, for example an action associated with a test, to be taken upon the element to be searched for, may be taken upon the element on the web page.

Another technical solution comprises training the AI engine. The AI engine may be trained upon the results obtained from a human or from another system, such as a previously available system, in which elements that may have been modified are searched for in a web page. For example, a human user or a previously available system may output the following tuple: attribute values of an element to be searched for, attribute values of an element on a web page, and a binary indication or a probability that the element on the web page is the element searched for. If the probability exceeds a predetermined threshold, for example 85%, 90% or the like, the element on the web page may be considered the searched element or a modification thereof. If the probability is below another predetermined threshold, lower than the first threshold, for example 25%, 30%, 40% or the like, the element on the web page may be considered not to be the searched element or a modification thereof. Cases in which the probability is between the first and the second thresholds may not be entered to the AI engine training set. Alternatively, in this case (and also if the probability is below the second threshold), a user using a Graphic User Interface may be prompted to indicate whether the element on the web page is the searched element.

Once trained, the AI engine may receive values of corresponding attributes of two elements, and output an indication whether one of the elements is a modification of the other.

Yet another technical solution comprises determining the attribute set of elements upon which the AI engine is to be trained, and which may be provided to the AI engine when activated. A typical application comprises hundreds or thousands of possible attributes, wherein a subset thereof may be assigned to each element of each page of a developed application. Some attributes may be predetermined and others may be defined and set by a developer of a web page. Typically, each element comprises a much smaller number of attributes than the total number.

Training an engine upon a smaller number of attributes requires less resources and input examples for training, and may provide for a more efficient engine. However, ignoring many elements may provide for insufficient accuracy. Suppose for example that an element comprises only one attribute. If this attribute is not in the attribute set, such element cannot be used for training the AI engine, and would not be resolved by a trained AI engine. On the other hand, using all possible attributes would require a large number of cases for training, and may provide for an inefficient system, in which for most elements, most attributes will have no value.

Thus a subset of all attributes may be selected, which balances between the number of elements it provides significant results of, and the efficiency.

Yet another technical solution comprises combining the AI engine decision with a decision by another engine, for example the engine that provided the probabilities upon which the AI engine was trained. In accordance with such combination, an element on a web page may be considered the element to be searched for, upon at least one of the AI engine so indicating, or the other engine confirming, e.g. providing a probability exceeding a predetermined threshold that the element on the web page is the element to be searched for. In further embodiments, it may be required that both engines confirm in order to consider the element on the web page as a modification of the element to be searched for.

One technical effect of the disclosure relates to providing a more accurate solution to detecting a web page element after having gone through some modification.

Another technical effect is the provisioning of an efficient and accurate method and system for repeating previously executed tests, in order to verify backward compatibility, or that no harm was done by additions or changes introduced to an application comprising one or more web pages. The method and system may be used cross-platform, for testing applications provided on or for one environment, comprising for example a platform, an operating system, graphic characteristics or the like, in a different environment.

Another technical effect is the selection of an attribute set upon which it is determined whether an element of a web page is the modification of an element to be searched for.

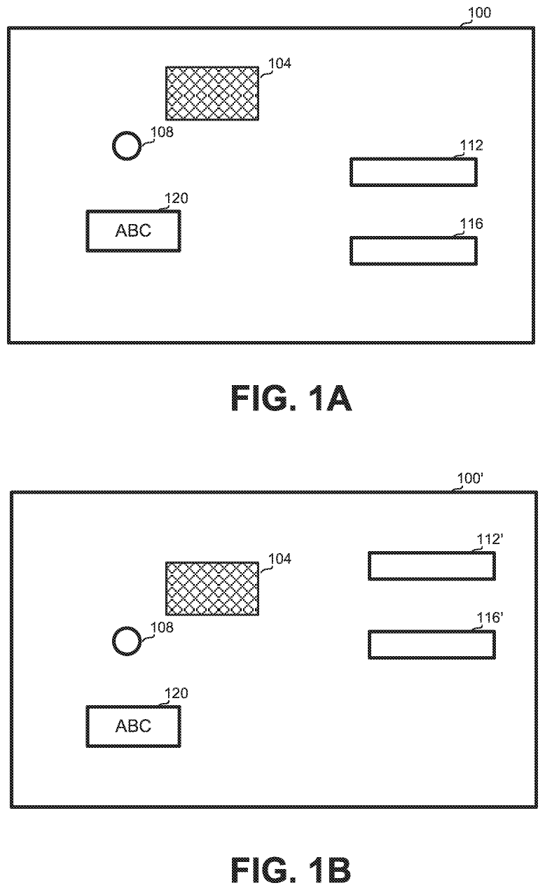

Referring now to FIGS. 1A and 1B, showing web page illustrations demonstrating the need for identifying a changed element. FIG. 1A is an illustration of a web page 100, comprising a bitmap 104, a button 108, a static text 120, and text boxes 112 and 116. A certain test may require entering text into text box 112.

FIG. 1B illustrates a slightly different version of the same page, denoted 100′. Page 100′ comprises bitmap 104, button 108, and static text 120 as in page 100, and text boxes 112′ and 116′ which are at an offset to text boxes 112 and 116 of page 100. If text box 112 is to be identified in accordance with its location, an automated test may erroneously identify text box 116′ as the required element, since it is located in page 100′ in the same location as text box 112 on page 100. In other situations, for example if the IDs of text boxes 112 and 112′ are different, and matching the element is performed based only on ID, no element will be identified at all.

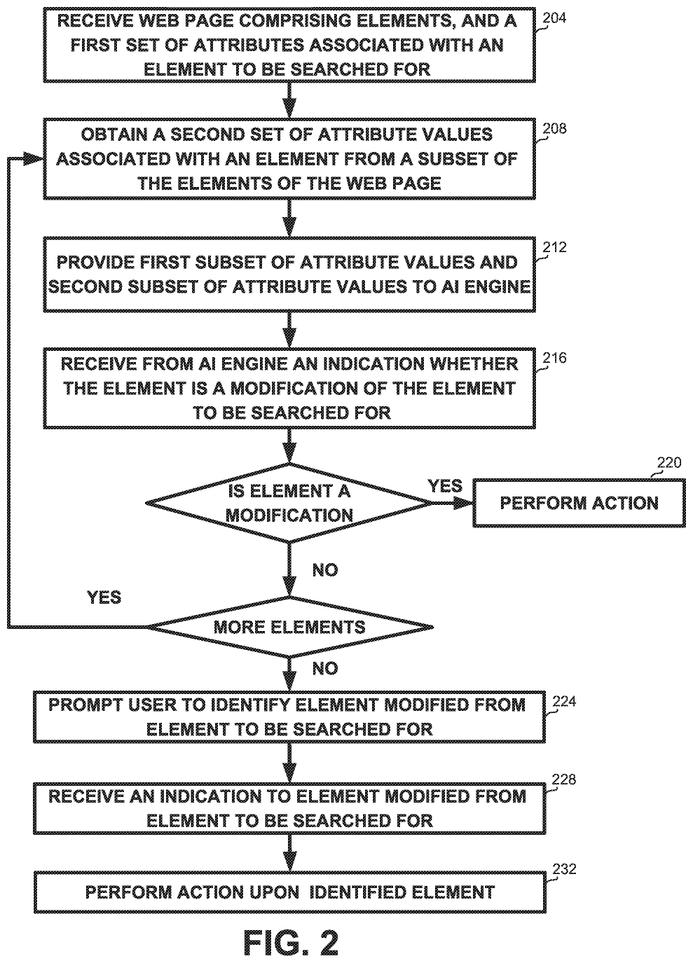

Referring now to FIG. 2, showing a generalized flowchart of a method for identifying an element in a web page, in accordance with some embodiments of the disclosure.

On step 204 a description of a web page may be received, for example in Hypertext Markup Language (HTML). The web page comprises one or more elements, some of which may have graphic representation, and some of which may not. Also received is a description of an element to be searched for within the web page. The elements of the web page, as well as the element to be searched for, may be represented as a set of pairs, each pair comprising an attribute and a corresponding attribute value. Some of the attributes, such as ID, location, or others may be predefined, while others may be user-specified. It is required to identify within the web page an element corresponding to the element to be searched for, whether it has exactly the same attributes, or is a modification thereof, for example one or more of the attributes have been changed.

On step 208, a second set of attribute values may be obtained from the web page, wherein the second set is part of a description of an element on the web page. The element may be retrieved by traversing the elements of the web page.

In some embodiments, a search for an exact match of the element may be performed, in order to immediately detect the element if it has not changed. In some embodiments, a preliminary check may be performed to select only a subset of the elements of the web page, for example by type, such that fewer elements have to be examined more intensively.

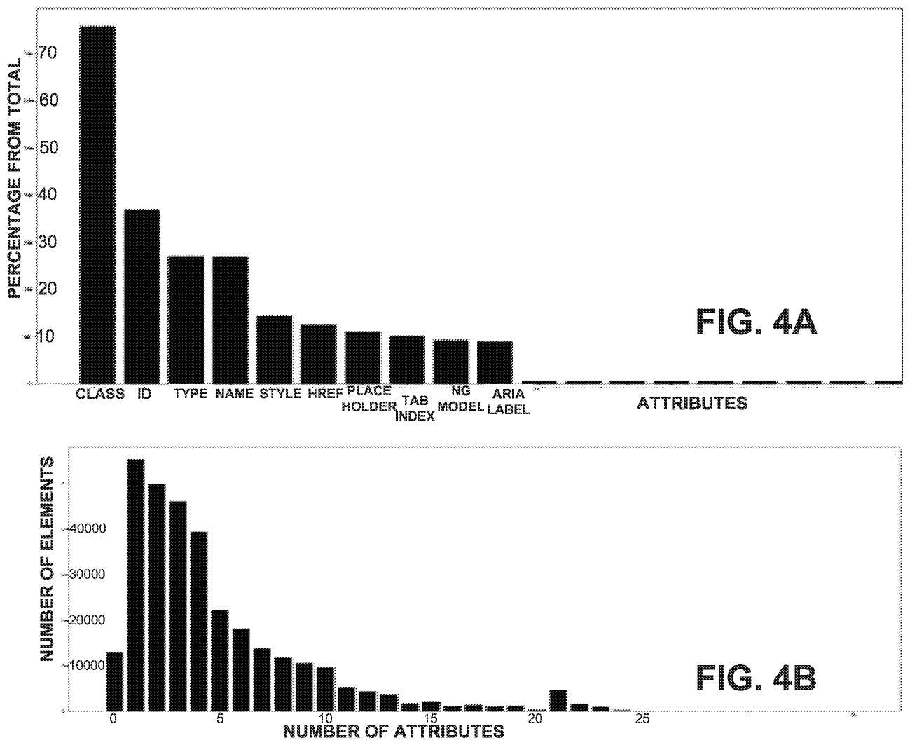

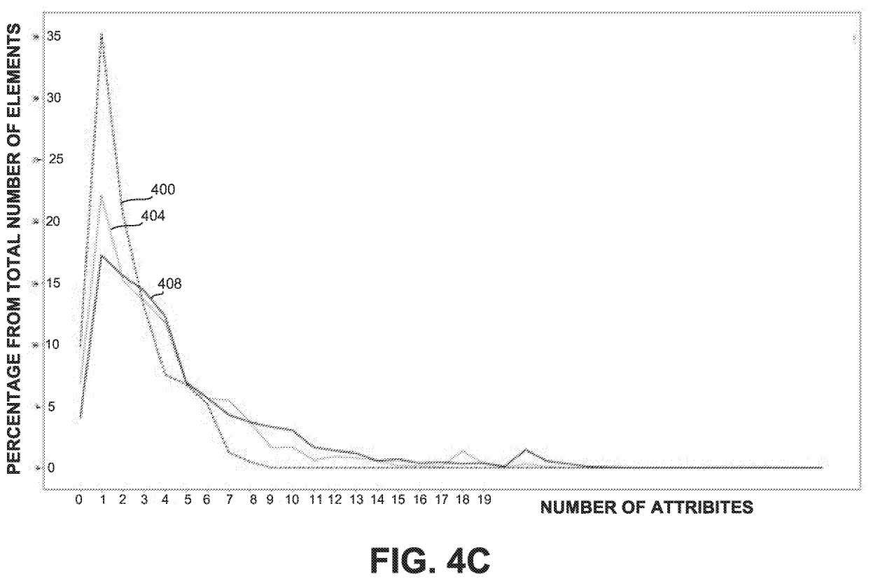

On step 212, at least a subset of the first set of attributes and attribute values, and at least a subset of the second set of attributes and attribute values may be provided to an AI engine, such as a neural network. It will be appreciated that the subsets correspond, i.e. comprise values for at least some common attributes. The subsets may be selected to be in compliance with a subset of the attributes upon which the AI engine has been trained. The attribute selection is further detailed in association with FIGS. 4A, 4B and 4C below.

On step 216, a response may be received from the AI engine, providing an indication, such as Yes/No answer to whether the second element is a modification, or a null modification of the searched element.

If the answer received from the AI engine is positive, then on step 220 an action, such as an action associated with an executed test may be performed upon the element of the web page. In other embodiments, if a positive indication is provided for a multiplicity of elements, the action may be performed upon one of them, as selected by other means, such as another engine.

If the answer is negative, steps 208, 212 and 216 may be repeated for other elements of the web page, until all elements are exhausted.

If no match is found between the element searched for and any of the elements of the web page, then on step 224 a user may be prompted to identify on the web page the element which was modified from the element searched for. The user may be prompted by a user interface, such as a graphic user interface, through one or more queries stored in a file, streamed to the user, or the like.

On step 228, an indication to the modified element may be received from the user using the user interface, or from another mechanism.

If the user identified the element, then on step 232 the action may be performed upon the identified element, similarly to step 220 above. The test may then proceed with further actions to be acted upon further elements.

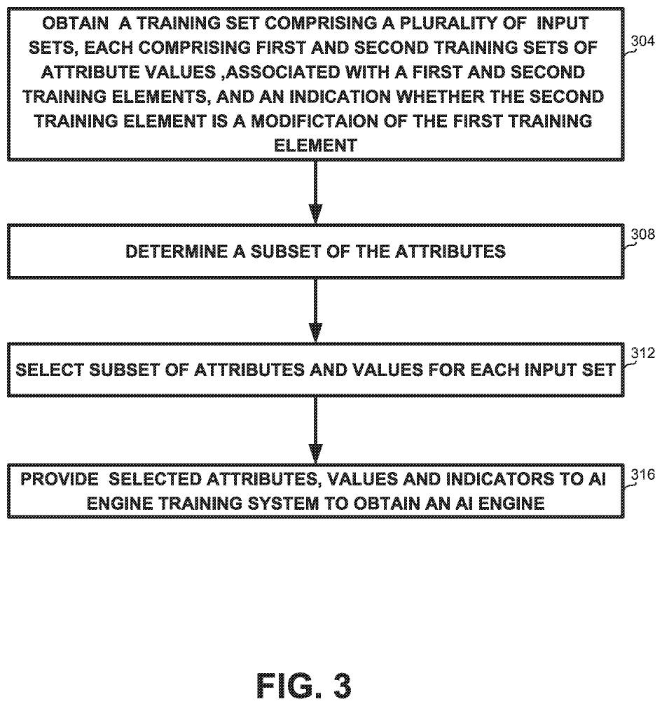

Referring now to FIG. 3, showing a generalized flowchart of a method for training an artificial engine for identifying elements in a web page, in accordance with some embodiments of the disclosure.

On step 304, a training set may be obtained. The training set may comprise a multiplicity of input sets, each input set comprising a first set of attributes and corresponding values representing an element to be searched, a second set of attributes and corresponding values representing an element on a web page, and an indicator of whether the element represented by the second set is a modification of the element to be searched for (or vice versa). The indication may be binary, for example yes/no, or numeric, for example a number representing a probability that the second element is a modification of the first. The training set may be obtained from a collection of decisions made by a previously available system, from a collections of decisions made by a human user, from generated examples in which elements have been modified, or the like.

On step 308, a subset of the attributes is determined, to minimize the required number of examples and to increase the efficiency and accuracy of the AI engine. The attribute selection is further detailed in association with FIGS. 4A, 4B and 4C below.

On step 312, a subset of the attribute values for each input set is filtered, such that for each pair the selected attributes and values are the common ones, which also belong to the attribute list determined on step 308. For example, if one element comprises values for ID, location and color, the other elements comprises values for ID, color and type, and the determined attributes include ID and type, the only attribute value that will be used is the ID.

On step 316, at least the selected attributes and values for each set, together with the indications, are provided to an AI engine training system, to obtain a trained engine, such as a neural network. It will be appreciated that the engine may be trained multiple times, for example three times, on the same or different inputs, for example different subsets of all available input. However, over-training is to be avoided in order to eliminate cases of overfitting, in which the engine is accurate, but only for the input set. Training may be done by any commercially available or proprietary training engine.

Referring now to FIGS. 4A, 4B and 4C, demonstrating the considerations in selecting the subset of attributes to be used for training the AI engine and matching elements. The graphs and histograms of FIGS. 4A, 4B and 4C are based on data collected during execution of re-runs of tests, for example regression tests, wherein during the tests over 320,000 elements have been matched. The elements contained over 2400 different attributes. It will be appreciated, and is also detailed below, that practically no element contained such a large number of attributes, rather this is the total number of attributes over all elements, wherein each element comprises a much smaller number of attributes.

It will be appreciated that using a larger number of attributes would provide a more accurate and robust system, since it is assumed that most of the attributes of the original element and of the modified element will be present, and will enable the matching. However, training an engine over a large number of attributes requires a large number of examples for training, comprising multiple values for multiple attribute combinations. Collecting such volume of examples may require a long time, a large diversity of elements of complex pages, and may thus be harder to gather. Additionally, the resource requirements of training and also of using a large number of attributes, including time and memory, are significantly higher than of using a smaller number of attributes. Considering this tradeoff, selecting the number of attributes is aimed at achieving a balance between the required resources and sufficient accuracy of the trained engine.

FIG. 4A shows a histogram of some attributes and the percentage of the elements comprising each attribute in the exemplary data. FIG. 4A shows the ten most frequent attributes, i.e., the ten attributes appearing in the largest number of elements, and the attributes ranked 90-100 (of ˜2400) in their frequency. It is seen that the most frequent attribute, being “Class” is included in over 70% of the elements, and the tenth most frequent attribute, being “Aria Label” appears in less than 15% of the elements. The 90-100 frequent elements appear in a negligible percentage of the elements. Thus, it may seem that a satisfactory number of elements would be between 10 and 90, between 20 and 80, between 50 and 70, or the like.

FIG. 4B shows a histogram of the number of elements for each particular number of attributes. It will be appreciated that in addition to the number of attributes, each element is also associated with some predetermined attributes, such as tagName, width, height and size, thus the shown number of attributes relates to the attributes additional to the predetermined ones. Thus, a significant number of the elements (over 50,000 out of about 320,000, i.e. about 15%) comprise one attribute, 35,000-50,000 elements comprise between two and four attributes, and few elements comprise over 13 attributes. For elements that comprise few attributes, for example up to seven attributes, and in particular for elements having up to four attributes, omitting even one attribute may result in disabling the matching of a modified element with an original one. For example, if an element comprises only an ID attribute and a second attribute, then if the ID of the element has changed, and the other attribute has been omitted, it would not be possible to match the modified element with the original one.

It would be appreciated that not all elements having the same number of attributes have the same attributes. For example, one element may comprise a single attribute being “Class”, while another element may comprise a single attribute being “ID”. Thus, it is required to select a larger number of attributes than the number of attributes for which the histogram of FIG. 4b drops almost to zero, for example over 25 attributes.

FIG. 4C shows three graphs, graph 400 related to the ten most frequent attributes, graph 404 related to the hundred most frequent attributes, and graph 408 related to all attributes. Each graph shows the percentage of all elements for each number of attributes, when only the number of attributes associated with the graph are considered and selected as those having the highest frequency. Thus, when considering the ten most frequent attributes, about 10% of the elements have no attribute (possibly these elements do have attributes, but none of the attributes belong to the ten most frequent ones). When considering 100 attributes, this number drops to about 6-7%, and when considering all attributes, drops again to about 4%. It is required to select a number of attributes, such that the selected attributes are contained in as many elements as possible.

In some test results, between about the 50 and 60 most frequent attributes, for example 55 attributes, have been selected. A neural network was trained, which comprises 75 neurons in the input layer, 16 neurons in a hidden layer, and 2 neurons in the output layer (one output neuron for “match” and another for “non-match”).

Training the neural network may comprise assigning applies weights to differences between values from the first set of attribute values and values of corresponding attributes from the second set of attribute values.

The accuracy, i.e. the number of elements matched correctly was about 96% for the training set and about 92% for another set.

It will be appreciated that selecting further elements may increase the accuracy.

Each selected attribute may be associated with a difference function, for evaluating the difference between the value of the attribute in the searched element, and the corresponding value in the element of the web page. For example, numeric attributes can use the absolute value of an arithmetic difference, string variables comparison may include checking for shifts or counting the number of identical characters, colors may be compared by taking the square root of the square of the difference in each color component, or the like.

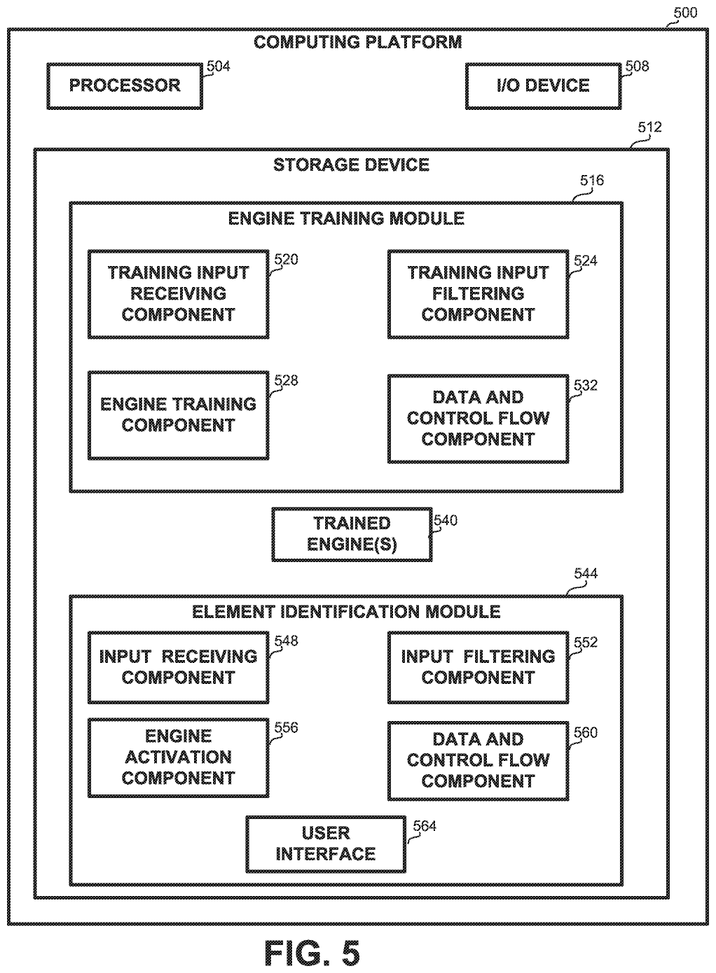

Referring now to FIG. 5, showing a generalized block diagram of a system for web page testing, in accordance with some embodiments of the disclosure.

The system comprises a computing platform 500, which may comprise one or more processors 504. Any of processors 504 may be a Central Processing Unit (CPU), a microprocessor, an electronic circuit, an Integrated Circuit (IC) or the like. Alternatively, computing platform 500 can be implemented as firmware written for or ported to a specific processor such as digital signal processor (DSP) or microcontrollers, or can be implemented as hardware or configurable hardware such as field programmable gate array (FPGA) or application specific integrated circuit (ASIC). Processors 504 may be utilized to perform computations required by computing platform 500 or any of its subcomponents. In some embodiments, computing platform 500 may comprise multiple computing platforms communicating using a communication channel, whether co-located or in multiple locations.

In some embodiments, computing platform 500 may comprise an input-output (I/O) device 508 such as a terminal, a display, a keyboard, an input device or the like to interact with the system, to invoke the system and to receive results, for example a display may be used for prompting the user to point at the specific element and to receive the user's input. It will however be appreciated that the system can operate without human operation and without I/O device 508.

Computing platform 500 may comprise one or more storage devices 512 for storing executable components, and which may also contain data during execution of one or more components. Storage device 512 may be persistent or volatile. For example, storage device 512 can be a Flash disk, a Random Access Memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like. In some exemplary embodiments, storage device 512 may retain program code operative to cause any of processors 504 to perform acts associated with any of the steps shown in FIG. 2 or FIG. 3 above, for example training an AI engine, identifying a specific element, or the like.

The components detailed below may be implemented as one or more sets of interrelated computer instructions, loaded to storage device 512 and executed for example by any of processors 504 or by another processor. The components may be arranged as one or more executable files, dynamic libraries, static libraries, methods, functions, services, or the like, programmed in any programming language and under any computing environment.

Storage device 512 may comprise engine training module 516 for training an AI engine, trained engine(s) 540, and element identification module 544 which may be used in runtime for identifying elements, for example as part of testing.

In some embodiments, computing platform 500 may comprise two or more computing platforms, each comprising or being operatively connected to one or more storage devices 512, wherein at least one of storage devices 512 comprises engine training module 516 used for training an engine, and at least another storage device 512 comprises element identification module 544 used for identifying elements in runtime. The two computing platforms may access, for example read or write, trained engine(s) 540, which may be located on either storage device 512 or on yet another computing platform.

In some embodiments the components of engine training module 516 may store training input receiving component 520 for receiving a multiplicity of input sets, each input set comprising a first collection of attribute and corresponding values representing a first element, a second collection of attribute and corresponding values representing a second element, and an indication whether the second element is a modification of the first element.

Engine training module 516 may store training input filtering component 524, for filtering from the first collection and the second collection the attributes that are common to the first and second collections and to a predetermined attribute list. Input filtering component 524 may also convert a non-binary indication of whether the second element is a modification of the first element, to a binary indication. For example, a value exceeding a first threshold may be converted to “1”, a value below a second threshold may be converted to “0”, and input sets with intermediate values may be ignored.

Engine training module 516 may store engine training component 528, for training an engine such as a neural network upon the filtered input. Engine training component 528 may be any commercial or proprietary component. Engine training component 528 may create or update one or more trained engines 540, which may be stored on the same storage device or on another storage device.

Engine training module 516 may store data and control flow component 532, for activating and providing the required input to the other components, for example activating training input receiving component 520, transferring the input to training input filtering component 524, and transferring the filtered input to engine training module 516.

Element identification module 544 may store input receiving component 548 for receiving a multiplicity of input sets, each input set comprising a first collection of attributes and corresponding values representing a first element, and a second collection of attributes and corresponding values representing a second element. The first element may be an element to be searched for, for example as part of executing a test in which it is required to apply an action to an element. The second element may be from a web page comprising a multiplicity of elements, wherein the web page or an application comprising the web page is being tested.

Element identification module 544 may store input filtering component 552, for filtering from the first collection and the second collection the attributes and values that are common to the first and second collections and to the predetermined attribute list, which was used for training the trained engine 540.

Element identification module 544 may store engine activation component 556 for activating trained AI engine 540, upon the filtered input data, to obtain an indication.

Element identification module 544 may store data and control flow component 560, for activating and providing the required input to the other components, for example activating input receiving component 548, transferring the input to input filtering component 552, and transferring the filtered input to trained engine 540. Data and control flow component 560 may be a part of a test execution component, designed for executing tests upon a web page, including extracting elements from the web page such that their attributes may be received by input receiving component 548, activating an action upon a recognized element, or the like.

Element identification module 544 may store user interface 564 for receiving input from the user and providing output to the user, using any one or more I/O devices 508. For example, user interface 564 may display the web page to the user and indicate the specific element, prompt the user to indicate the specific element in runtime if the element is not identified, display test results, or the like.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method performed by a computerized device, comprising:
obtaining a first set of attribute values assigned to a first set of attributes associated with an element to be searched for in a web page;
obtaining a second set of attribute values assigned to a second set of attributes associated with an existing element present in the web page;
providing the first set of attribute values and the second set of attribute values to an artificial intelligence engine;
receiving from the artificial intelligence engine an indication whether the existing element is the element to be searched for; and
subject to the existing element being a modification of the element to be searched for, performing an action upon the existing element.

2. The computer-implemented method of claim 1, further comprising:
receiving a web page and the first set of attribute values;
identifying at least a subset of elements present on the web page; and
repeating said obtaining the second set, said providing the first set of attribute values and the second set of attribute values to the artificial intelligence engine, and said receiving, for at least one element of the subset of elements; and
performing the action upon the existing element subject to identifying the existing element from the subset for which the artificial intelligence engine provided an indication that the specific element is a modification of the element to be searched for.

3. The computer-implemented method of claim 2, wherein subject to not identifying the specific element from the subset for which the artificial intelligence engine provided an indication that the specific element is a modification of the element to be searched for:
prompting a user to identify the element modified from the element to be searched for;
receiving an indication from the user to the element modified from the element to be searched for from the user; and
performing the action upon the element modified from the element to be searched for.

4. The computer-implemented method of claim 1, wherein the artificial intelligence engine is a neural network.

5. The computer-implemented method of claim 4, wherein the neural network applies weights to differences between values from the first set of attribute values and values of corresponding attributes from the second set of attribute values.

6. The computer-implemented method of claim 4, further comprising training the neural network upon a multiplicity of input sets, each input set comprising: a first set of attribute values associated with a first element, a second set of attribute values associated with a second element, and an indication of whether the first element is the same as or a modification of the second element, or not.

7. The computer-implemented method of claim 6, wherein the indication is positive if a probability that the first element is the same as the second element exceeds a first threshold, and negative if the probability is below a second threshold, the second threshold being lower than the first threshold.

8. The computer-implemented method of claim 7, wherein the probability is obtained by an element matching system.

9. The computer-implemented method of claim 7, wherein subject to the probability that the first element is the same as the second element being below the first threshold, and above the second threshold, a user is asked whether the first element is the same as the second element.

10. A computer-implemented method performed by a computerized device, comprising:
obtaining a training set comprising a multiplicity of input sets, each input set comprising:
a first training set of attribute values associated with a first training element,
a second training set of attribute values associated with a second training element, and
an indication of whether the second training element is a modification of the first training element;
selecting a training set of attributes, such that in each input set the first training set and the second training set comprise values for at least one attribute from the training set of attributes;
providing to an artificial intelligence training system at least a part of the training set, in which each input set comprises values associated with the training set of attributes from the first training set of attribute values, and values associated with the training set of attributes from the second training set of attribute values; and
activating the artificial intelligence training system upon the at least part of the training set, to obtain an artificial intelligence engine, the artificial intelligence engine adapted to:
receive a first runtime set of attribute values associated with a first runtime element, and a second runtime set of attribute values assigned to a second set of attributes associated with a second runtime element; and
output an indication of whether the second runtime element is a modification of the first runtime element.

11. The computer-implemented method of claim 10, wherein the artificial intelligence engine is a neural network.

12. The computer-implemented method of claim 11, wherein training the neural network comprises applying weights to differences between values from the first training set of attribute values and values of corresponding attributes from the second training set of attribute values.

13. The computer-implemented method of claim 10, wherein the indication is positive if a probability that the first training element is a modification of the second element exceeds a first threshold, and negative if the probability is below a second threshold, the second threshold being lower than the first threshold.

14. The computer-implemented method of claim 13, wherein the probability is obtained from an element matching system.

15. The computer-implemented method of claim 13 wherein subject to the probability that the first training element is the same as the second element being between the first threshold and the second threshold, a user is prompted to indicate whether the first training element is the same as the second element.

16. A computerized apparatus having a processor, the processor being adapted to perform the steps of:
obtaining a training set comprising a multiplicity of input sets, each input set comprising:
a first training set of attribute values associated with a first training element,
a second training set of attribute values associated with a second training element, and
an indication of whether the second training element is a modification of the first training element;
selecting a training set of attributes, such that in each input set the first training set and the second training set comprise values for at least one attribute from the training set of attributes;
providing to an artificial intelligence training system at least a part of the training set, in which each input set comprises values associated with the training set of attributes from the first training set of attribute values, and values associated with the training set of attributes from the second training set of attribute values; and
activating the artificial intelligence training system upon the at least part of the training set, to obtain an artificial intelligence engine, the artificial intelligence engine adapted to:
receive a first runtime set of attribute values associated with a first runtime element, and a second runtime set of attribute values assigned to a second set of attributes associated with a second runtime element; and
output an indication of whether the second runtime element is a modification of the first runtime element.

17. The apparatus of claim 16, wherein the artificial intelligence engine is a neural network.

18. The apparatus of claim 17, wherein training the neural network comprises applying weights to differences between values from the first training set of attribute values and values of corresponding attributes from the second training set of attribute values.

19. The apparatus of claim 16, wherein the indication is positive if a probability that the first training element is a modification of the second element exceeds a first threshold, and negative if the probability is below a second threshold, the second threshold being lower than the first threshold.

20. A computer program product comprising a non-transitory computer readable medium retaining program instructions, which instructions when read by a processor, cause the processor to perform:
obtaining a training set comprising a multiplicity of input sets, each input set comprising:
a first training set of attribute values associated with a first training element,
a second training set of attribute values associated with a second training element, and
an indication of whether the second training element is a modification of the first training element;
selecting a training set of attributes, such that in each input set the first training set and the second training set comprise values for at least one attribute from the training set of attributes;
providing to an artificial intelligence training system at least a part of the training set, in which each input set comprises values associated with the training set of attributes from the first training set of attribute values, and values associated with the training set of attributes from the second training set of attribute values; and
activating the artificial intelligence training system upon the at least part of the training set, to obtain an artificial intelligence engine, the artificial intelligence engine adapted to:
receive a first runtime set of attribute values associated with a first runtime element, and a second runtime set of attribute values assigned to a second set of attributes associated with a second runtime element; and
output an indication of whether the second runtime element is a modification of the first runtime element.
